(19) United States
(12) Patent Application Publication
(10) Pub. No.: US 2009/0033858 A1
(43) Pub. Date: Feb. 5, 2009

(54) Liquid crystal display device and manufacturing method of the same

(75) Inventors: Takashi Yamamoto, Chiba (JP); Sadafumi Hirai, Mobara (JP); Hiroaki Miwa, Yokohama (JP); Setsuo Kobayashi, Mobara (JP)

Correspondence Address: Stanley P. Fisher;Reed Smith LLP, 3110 Fairview Park Drive, Suite 1400, Falls Church, VA, 22042-4503, US

(73) Assignee: Hitachi Displays, Ltd.

(21) Appl. No.: 12/219,579

(22) Filed: Jul. 24, 2008

(30) Foreign Application Priority Data
Aug. 1, 2007 (JP) 2007-200343

(51) Int. Cl. G02F 1/1339

(52) U.S. Cl. 349/154; 445/25

(57) ABSTRACT

A manufacturing method is provided for a liquid crystal display device that can avoid any possible inconvenience as a result of a difficulty in controlling the dropping amount of a liquid crystal. For executing the method, the liquid crystal display device has a pair of substrates disposed in an opposed manner including a liquid crystal display area with a diagonal length in a range from 1 inch to 5 inches, and a plurality of column spacers is formed in the liquid crystal display area of at least one of the substrates. The method includes the steps of: forming a sealant, with a width in a range from 0.4 mm to 1.0 mm, around the liquid crystal display area of the substrate formed with the column spacers; dropping a liquid crystal into the area enclosed by the sealant on the substrate such that a surface of the liquid crystal has a height lower than a height of the column spacers; disposing the other substrate to be opposed to the substrate formed with the column spacers, and pushing the resulting pair of substrates in a direction bringing the substrates closer to each other; and curing the sealant in a state that the column spacers each have the height in a percentage range from 108% to 113% as a result of dividing the height without the pushing by the height with the pushing.

The present application claims priority from Japanese application JP2007-200343 filed on Aug. 1, 2007, the content of which is hereby incorporated by reference into this application.

### BACKGROUND OF THE INVENTION

The present invention relates to a liquid crystal display device and a manufacturing method of the device and, more specifically, to a liquid crystal display device configured using the so-called One Drop Fill (ODF) process and a manufacturing method of the device.

For configuring a liquid crystal display device using the One Drop Fill process, on one of a pair of opposing substrates with a liquid crystal sandwiched therebetween, a sealant is formed like a closed curve to enclose the area of the liquid crystal display. On the area enclosed by the sealant as such, a liquid crystal is dropped.

To the resulting substrate formed with the sealant, the remaining substrate is opposingly disposed, and the resulting pair of substrates is pushed in the direction of bringing the substrates close to each other. At the time point when any desired cell gap is derived, the sealant is cured.

In this case, to derive any desired value for the cell gap between the pair of substrates, a spacer is generally disposed therebetween. This spacer is a so-called column spacer formed by selective etching of a resin layer to produce any predetermined pattern. The resin layer here is the one formed to the area of the liquid crystal display of one of the substrates.

The configuration of such a liquid crystal display device is described in the following Patent Document 1 (JP-A-2002-40451) or Patent Document 2 (JP-A-2006-232894), for example.

Herein, in contrast to the One Drop Fill process, there is a method of liquid crystal injection. With the method of liquid crystal injection, on one of a pair of opposing substrates with a liquid crystal sandwiched therebetween, a sealant is formed like an open curve to enclose the area of the liquid crystal display. To the resulting substrate formed with the sealant, the remaining substrate is opposingly disposed so that any desired cell gap is derived.

The liquid crystal is then injected between the substrates with the aperture portion of the sealant used as an injection port. Thereafter, the injection port is sealed using a sealing compound.

### SUMMARY OF THE INVENTION

The above-described One Drop Fill process has been of limited application to a liquid crystal display device with a relatively large panel. This is because applying the method of liquid crystal injection to manufacture a liquid crystal display device of a relatively large panel size has required a long time for the process of injection, thereby resulting in the poor workability. For measures against such a problem, if an attempt is made to reduce the thickness by narrowing down the gap between the substrates, injecting the liquid crystal causes a difficulty, thereby requiring a much longer time.

In recent years, also for middle- or small-sized liquid crystal display devices, the demand has been increasing surely for higher definition and also for lower profile. To meet such a demand, the attempt has been made to apply the One Drop Fill process to manufacture a liquid crystal display device of a middle- or small panel size.

However, the study result tells that applying the One Drop Fill process to manufacture a middle- or small-sized liquid crystal display device causes the following inconveniences due to the fewer number of spots for dropping of a liquid crystal, and the resulting difficulty in controlling the dropping amount of the liquid crystal.

That is, when the dropping amount of the liquid crystal becomes larger than the appropriate amount, the liquid crystal will be increased in internal pressure when the pair of opposing substrates is pushed in the direction of bringing the substrates close to each other to derive any desired cell gap. As a result of the internal pressure increased as such, the sealant not yet cured will suffer from a so-called phenomenon of penetration of the liquid crystal, i.e., the liquid crystal penetrates, partially, into the sealant like needles, and at the worst, the sealant may be damaged.

When the dropping amount of the liquid crystal becomes smaller than the appropriate amount, even if an attempt is made to sufficiently reduce the space between the pair of substrates by pushing the substrates in the direction of bringing those close to each other similarly to the above, the column spacer is not accordingly changed in shape. As a result, the amount of liquid crystal is not enough considering the volume in the panel, thereby causing vacuum bubbles in the area around the panel.

Therefore, an object of the invention is to provide a liquid crystal display device that can avoid any inconvenience associated with the difficulty in controlling the dropping amount of a liquid crystal, and a manufacturing method of the device.

Note that the above-described liquid crystal display devices of Patent Documents 1 and 2 are both of the large size, and are failing to suggest the object of the invention.

In the invention disclosed in this specification, typical aspects are briefly described as below.

That is, a first typical aspect of the invention is characteristically directed to a manufacturing method of a liquid crystal display device having a pair of substrates disposed in an opposed manner including a liquid crystal display area with a diagonal length in a range from 1 inch to 5 inches, and a plurality of column spacers is formed in the liquid crystal display area of at least one of the substrates. The method includes the steps of: forming a sealant, with a width in a range from 0.4 mm to 1.0 mm, around the liquid crystal display area of the substrate formed with the column spacers; dropping a liquid crystal into the area enclosed by the sealant on the substrate such that a surface of the liquid crystal has a height lower than a height of the column spacers; disposing the other substrate to be opposed to the substrate formed with the column spacers, and pushing the resulting pair of substrates in a direction bringing the substrates closer to each other; and curing the sealant in a state that the column spacers each have the height in a percentage range from 108% to 113% as a result of dividing the height without the pushing by the height with the pushing.

According to a manufacturing method of a liquid crystal display device in a second typical aspect of the invention, exemplarily in the first typical aspect, characteristically, the diagonal length of the liquid crystal display area is set in a range from 1 inch to 4 inches.

According to a manufacturing method of a liquid crystal display device in a third typical aspect of the invention, exemplarily in the first or second typical aspect, characteristically, the width of the sealant is set in a range from 0.55 mm to 0.85 mm.

A fourth typical aspect of the invention is characteristically directed to a liquid crystal display device that includes: a pair of substrates disposed in an opposed manner with a liquid crystal sandwiched therebetween; a sealant being formed around a liquid crystal display area in which the liquid crystal is sealed between the pair of substrates, and having no remaining trace of a liquid crystal sealing port throughout an entire length thereof; and a plurality of column spacers each fixed inside of the liquid crystal display area of one of the pair of substrates. In the device, a diagonal length of the liquid crystal display area is in a range from 1 inch to 5 inches, and the sealant has a width set in a range from 0.4 mm to 1.0 mm, and the column spacers each have a height set to have a percentage range from 108% to 113% as a result of dividing a height of the column spacers in a state that only said one of the pair of substrates exists by a height of the column spacers in a state that both of the substrates attached together.

According to a manufacturing device in a fifth typical aspect of the invention, exemplarily in the fourth typical aspect, characteristically, the diagonal length of the liquid crystal display area is set in a range from 1 inch to 4 inches.

According to a manufacturing device in a sixth typical aspect of the invention, exemplarily in the fourth or fifth typical aspect, characteristically, the width of the sealant is set in a range from 0.55 mm to 0.85 mm.

Note here that the foregoing description is in all aspects illustrative and not restrictive, and it is understood that numerous other modifications and variations can be devised without departing from the scope of the invention.

With the liquid crystal display device configured as such and the manufacturing method of the device, any inconvenience possibly associated with the difficulty in controlling the dropping amount of a liquid crystal can be favorably avoided.

### BRIEF DESCRIPTION OF THE DRAWINGS

FIGS. 1A and 1B are each a diagram showing the shape change of column spacers during manufacturing of a liquid crystal display device of the invention, and the resulting state of a liquid crystal;

FIG. 2 is a diagram showing the schematic configuration of an exemplary liquid crystal display device of the invention;

FIG. 3 is an equivalent circuit diagram showing an exemplary pixel of the liquid crystal display device of the invention;

FIG. 4 is a diagram showing the main components of the liquid crystal display device of the invention, i.e., a cross sectional view thereof cut along a line IV-IV of FIG. 2;

FIGS. 5A to 5D are diagrams showing the process procedure using the One Drop Fill process during manufacturing of the liquid crystal display device of the invention;

FIG. 6 is a diagram showing so-called multiple cutting during manufacturing of the liquid crystal display device of the invention;

FIGS. 7A and 7B are each a diagram showing inconveniences caused in a previous liquid crystal display device; and

FIGS. 8A and 8B are also each a diagram showing the inconveniences caused in the previous liquid crystal display device.

### DESCRIPTION OF THE PREFERRED EMBODIMENT

In the below, described is a liquid crystal display device in an embodiment of the invention by referring to the accompanying drawings.

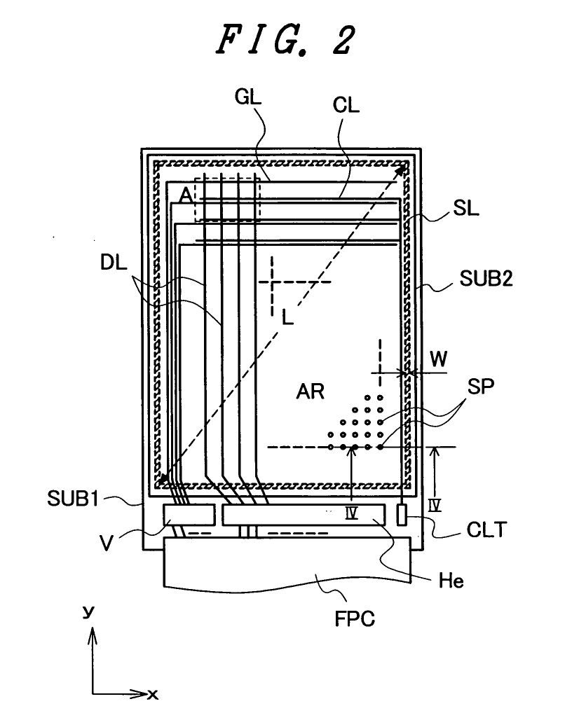

FIG. 2 is a plan view of the liquid crystal display device in the embodiment of the invention, showing the schematic configuration thereof.

In FIG. 2, substrates SUB1 and SUB2 are each made of transparent glass, for example, and these substrates SUB1 and SUB2 are disposed opposing each other with a liquid crystal sandwiched therebetween.

The substrate SUB1 is made slightly larger in area than the substrate SUB2, and the lower portion of the substrate SUB1 is exposed from the substrate SUB2. The lower portion is mounted thereon with a scan signal drive circuit V and a video signal drive circuit He, which are each a semiconductor device. To the scan signal drive circuit V and the video signal drive circuit He, signals are directed via a flexible substrate FPC connected to the end side of the lower portion of the substrate SUB1. Herein, the scan signal drive circuit V and the video signal drive circuit He may be both directly formed to the surface of the substrate SUB1.

The substrate SUB2 is fixed to the substrate SUB1 using a sealant SL formed around the substrate SUB2, and this sealant SL serves also to seal the liquid crystal.

This sealant SL is formed in a rectangular shape to enclose a liquid crystal display area AR, and through the entire length in the longitudinal direction thereof, there is no remaining trace of a liquid crystal sealing port. Here, the remaining trace of a liquid crystal sealing port denotes a portion of the sealant SL where a port for sealing the liquid crystal into the liquid crystal display area AR is formed and sealed by a sealing compound. That is, the sealant SL of the invention is formed like a closed curve.

In such a liquid crystal display device, the reason of the sealant SL configured as such is the so-called One Drop Fall process being applied for sealing a liquid crystal into the liquid crystal display area AR. This One Drop Fall process will be described in detail later.

The sealant SL has the relatively narrow width, being in a range from 0.4 mm to 1.0 mm, more preferably, in a range from 0.55 mm to 0.85 mm.

The reason of the sealant SL formed with such a narrow width is that the so-called panel size in mind in this liquid crystal display device is relatively small, and in accordance with the small size, the width of the sealant SL is set to fall in the above ranges.

As shown in FIG. 2, the panel size of the liquid crystal display device is defined by a diagonal length L of the liquid crystal display area AR, and in this liquid crystal display device, the diagonal length L is set in a range from 1 inch to 5 inches, more preferably, in a range from 1 inch to 4 inches. The circumferential area not including the liquid crystal display area AR, i.e., frame area, is preferably smaller.

Note here that, in terms of space as such, there is no need to enhance the strength of the sealant SL by configuring the sealant SL in the dual structure, for example, and as shown in the drawing, the sealant SL is in the single structure.

On the surface of the liquid crystal display area AR on the liquid crystal side of the substrate SUB1, a plurality of gate signal lines GL and a plurality of drain signal lines DL are formed. The gate signal lines GL are extended in the direction of x in the drawing, and are disposed in line in the direction of y, and the drain signal lines DL are extended in the direction of y with insulation from the gate signal lines GL, and are disposed in line in the direction of x. The rectangular areas enclosed by these signal lines are each configured as a pixel area. The configuration of a pixel will be described in detail later.

The gate signal lines GL are each extended beyond the sealant SL with its one end (left end in the drawing) being routed, and are connected to the scan signal drive circuit V. The scan signal drive circuit V is so configured as to provide a scan signal to each of the gate signal lines GL in a sequential manner, e.g., from the top to bottom in the drawing.

As to the drain signal lines DL, their one ends (lower ends in the drawing) are each extended beyond the sealant SL, for example, and are connected to the video signal drive circuit He. The video signal drive circuit He is so configured as to provide a video signal to each of the drain signal lines DL at a supply timing of the scan signal by the scan signal drive circuit V.

That is, in response to a supply of the scan signal, any pixel row sharing the corresponding gate signal line is selected, and at this time, a video signal is to be supplied over any of the drain signal lines corresponding to the pixels configuring the pixel row.

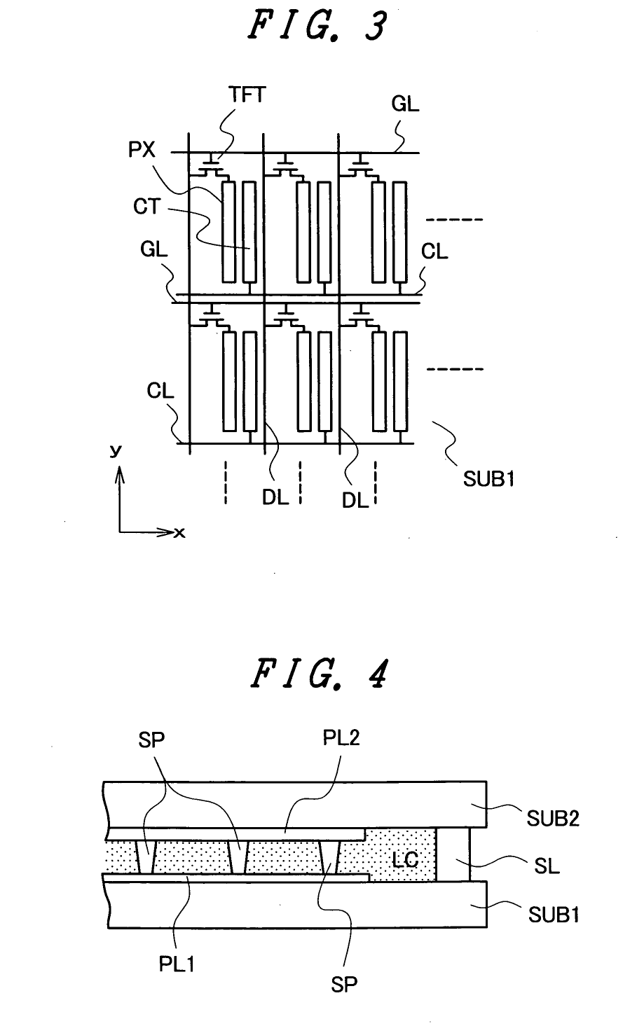

FIG. 3 is an equivalent circuit diagram showing an exemplary configuration of the pixel. FIG. 3 corresponds to the portion enclosed by a dotted frame A of FIG. 2, and indicates the pixels of 2×3.

In FIG. 3, in an area enclosed by a pair of adjacent gate signal lines GL and a pair of adjacent drain signal lines DL, a thin-film transistor TFT, a pixel electrode PX, and an opposing electrode CT are provided so that a pixel PIX is configured. The thin-film transistor TFT is turned ON in response to a supply of scan signal from the gate signal lines GL. The pixel electrode PX is provided with a video signal from the drain signal lines DL via the thin-film transistor TFT that has been turned ON. The opposing electrode CT generates an electric field with the pixel electrode PX.

The opposing electrode CT is connected to a common signal line CL, which is shared by the pixels in the same pixel row, and the common signal line CL is connected to a common terminal CLT (FIG. 2) on the substrate SUB1 beyond the sealant SL. With such a configuration, the opposing electrode CT receives a signal (voltage) for use as a reference for the video signal through the common terminal CLT.

Note that, in the pixel configuration in this embodiment, a pixel electrode PX and an opposing electrode CT are provided in the pixel area on the side of the substrate SUB1. This configuration is surely not restrictive, and alternatively, a pixel electrode PX may be provided to the pixel area on the side of the substrate SUB1, and on the surface of the liquid crystal side of the substrate SUB2 opposing the substrate SUB1, an opposing electrode may be formed for shared use among the pixel areas.

FIG. 3 is an equivalent circuit showing the pixel configuration. The circuit on the surface of the substrate SUB1 on the liquid crystal side is configured as a laminate in which layers are laminated in any desired order. These layers include a conductive layer, a semiconductor layer, an insulator layer, or others, which are formed in any desired pattern by selective etching of the photolithographic technology.

On the surface on the liquid crystal side of the substrate SUB2 opposing the substrate SUB1, a black matrix and a laminate are provided. The black matrix is formed to maintain a space between any adjacent pixel areas. In the laminate, a color filter or others formed to cover the aperture of the black matrix are laminated.

FIG. 4 is a diagram showing the cross-sectional view of the liquid crystal display device of FIG. 2 cut along a line IV-IV. In FIG. 4, the surface of the substrate SUB1 on the side of the liquid crystal LC is formed with a laminate PL1 as a result of lamination, in any desired order, of a conductive layer, a semiconductor layer, an insulator layer, or others, which are formed in any desired pattern. The surface of the substrate SUB2 on the side of the liquid crystal LC is formed with a laminate PL2 as a result of lamination of a black matrix, a color filter, and others.

On the surface of the laminate PL2 of the substrate SUB2, a plurality of column spacers SP are formed, for example. These spacers SP are scattered throughout the liquid crystal display area AR uniformly on the basis of a pixel or a plurality of pixels.

These column spacers SP are each formed by patterning the layer formed on the surface of the substrate SUB2, e.g., resin layer, by selective etching of the photolithographic technology. The column spacers SP are formed at their predetermined positions with almost the same height.

These column spacers SP are formed at their corresponding positions in the pixel area, e.g., above the drain signal lines DL or the gate signal lines GL.

By forming the column spacers SP at the positions away from the substantial pixel area, i.e., aperture portion of the black matrix, any light dispersion possibly caused by the column spacers SP can be favorably avoided, and the column spacers SP can be stably disposed, thereby being able to position the top portions thereof, i.e., portions on the side coming in contact with the substrate SUB1, at the height almost uniformly with respect to the surface of the substrate SUB1.

Such column spacers SP enable the cell gap to remain at a predetermined value. The cell gap is the thickness of the liquid crystal LC in the transmission sections of the pixels, i.e., substantial pixel areas, throughout the entire liquid crystal display area AR.

The cell gap is set in accordance with the size of the liquid crystal display device. In this embodiment, as described above, the cell gap is set to be about 4 μm, for example, because the diagonal length L of the liquid crystal display area AR is set in a range from 1 inch to 5 inches.

As such, the height of the column spacers SP in the liquid crystal display device being a finished product takes a value approximate to the value of the cell gap, but the height of the column spacers SP does not generally take the same value as the cell gap in the strict sense. This is because the surface of the laminate PL2 on the liquid crystal side is made uneven, and with respect to the surface of the substrate SUB2, the surface height of the laminate PL1 will not thus be the same, i.e., the height of the portion of the laminate PL1 where the column spacers SP are fixed is different from the height of the portion the laminate PL1 in the transmission section of the pixel.

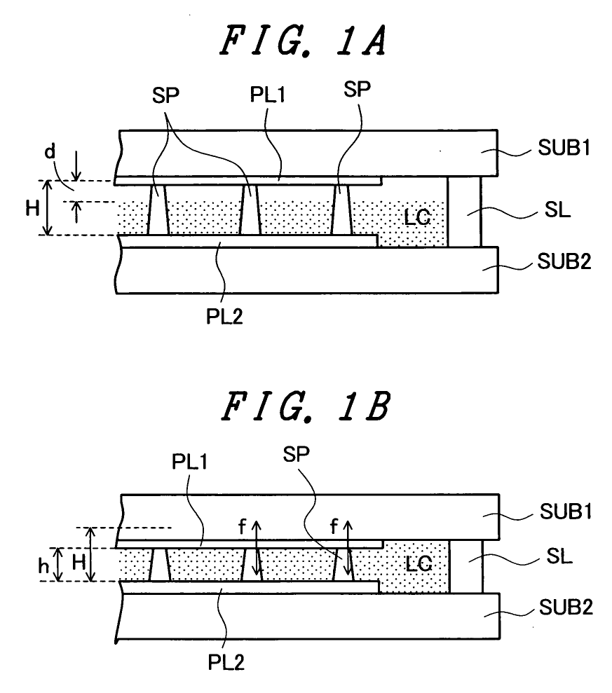

In the liquid crystal display device in the embodiment, the column spacers SP are so configured that the height thereof after the device is completed as a finished product (denoted by h in FIG. 1B) has a fixed relationship with the height thereof not yet pushed by the substrate SUB2 in the manufacturing process of the liquid crystal display device (denoted by H in FIG. 1A)

This relationship will be described in detail later by referring to FIGS. 1A and 1B. Prior thereto, described is a process of sealing a liquid crystal between the substrates SUB1 and SUB2 of the liquid crystal display device using the sealant SL with the One Drop Fall process applied. Also described is the reason why the spacers SP are pushed by the substrate SUB1 during the sealing process.

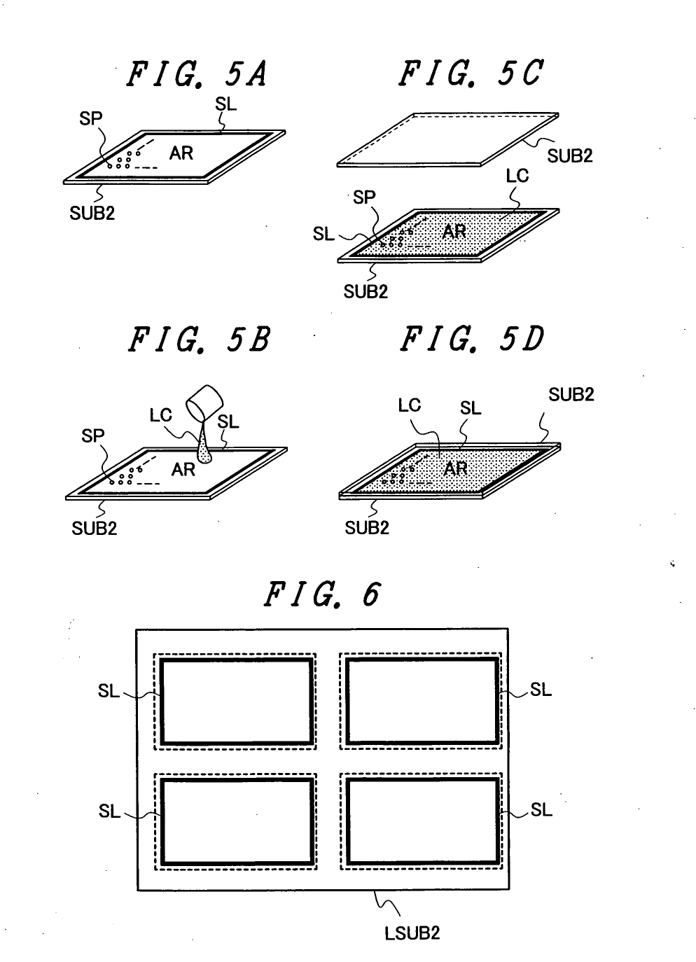

FIGS. 5A to 5D are diagrams showing the process procedure in the liquid crystal display device, i.e., sealing a liquid crystal between the substrates SUB1 and SUB2 by the sealant SL.

First of all, as shown in FIG. 5A, the substrate SUB2 is made ready. This substrate SUB2 is already formed with, on the surface on the liquid crystal side, the laminate PL2 and the column spacers SP of FIG. 4.

On the surface of the substrate SUB2 on the liquid crystal side, the sealant SL is so formed as to enclose the liquid crystal area AR. This sealant SL is formed, using a dispenser, for example, to have the width in a range from 0.4 mm to 1.0 mm.

The liquid crystal display area AR enclosed by the sealant SL as such has the diagonal length in a range from 1 inch to 5 inches.

Next, as shown in FIG. 5B, the liquid crystal LC is dropped on the liquid crystal display area AR enclosed by the sealant SL so that the liquid crystal LC is filled in the liquid crystal display area AR.

Dropping of the liquid crystal LC at this time is limited in the allowed number of spots for dropping, e.g., one- or two-spot dropping, because the liquid crystal display area AR is relatively small in size. This thus leads to a difficulty in controlling with accuracy the dropping amount of the liquid crystal. Even this is the case, however, the dropping amount of the liquid crystal LC to be filled in the liquid crystal display area AR can be set to a value allowing the top portions of the spacers SP to be slightly protruded from the surface of the liquid crystal LC.

Next, as shown in FIG. 5C, the substrate SUB1 is made ready. This substrate SUB1 is already formed with the laminate PL1 of FIG. 4 on the surface on the liquid crystal side.

As shown in FIG. 5D, the substrate SUB1 is so positioned as to oppose the substrate SUB2, and the substrate SUB1 is then pushed to the side of the substrate SUB2. In this case, the spacers SP formed on the side of the substrate SUB2 receive the force from the substrate SUB1, thereby slightly changing in shape to be lower in height.

When the substrate SUB1 is changed in shape to have a predetermined cell gap with respect to the substrate SUB2, the sealant SL is cured by irradiation of ultraviolet rays, for example. This accordingly leads to a panel in which the liquid crystal LC is sealed between the substrates SUB1 and SUB2 by the sealant SL.

Note that, in the above description given by referring to FIGS. 5A to 5D, for the sake of easy understanding, the process procedure is described in terms of the relationship between the substrates SUB1 and SUB2 in a liquid crystal display device. In the real world, however, so-called multiple cutting is adopted for increasing the manufacturing efficiency, and this cutting corresponds to the process of FIG. 5A, for example. As shown in FIG. 6, a substrate LSUB2 relatively large in size is made ready, i.e., a substrate whose surface is divided into a plurality of areas, e.g., four in the drawing, and each of the areas is formed with the laminate PL2 and the column spacers SP, which are the same as those formed on the surface of the substrate SUB2. Each of the areas is then formed with the sealant SL. In FIG. 6, the portions enclosed by dotted lines each indicate the portion of the substrate LSUB2 for cutting into a plurality of substrates SUB2.

By referring to FIGS. 1A and 1B, described now is the shape change of the column spacers SP and the resulting state of the liquid crystal in the manufacturing process of a liquid crystal display device using such a One Drop Fall process.

FIG. 1A is a diagram showing a case where, after the liquid crystal LC is filled to the area of the substrate SUB2 enclosed by the sealant SL, the substrate SUB1 is so positioned as to oppose the substrate SUB2 but the column spacers SP are not yet depressed.

Note that, for consistency with the process procedure of the One Drop Fall process shown in FIGS. 5A to 5D, in FIG. 1A, the substrate SUB2 is located on the lower side, and the substrate SUB1 is located on the upper side.

In this case, the spacers SP are each under the gravity of the substrate SUB1, and not yet changed in height H, e.g., 3.95 μm to 4.1 μm. The height H remains the same as the height of the spacers SP formed on the surface of the substrate SUB2.

Dropping of the liquid crystal LC is performed to the level that the top portions of the spacers SP protrude slightly from the surface of the liquid crystal LC. For example, the height of the spacers SP from the surface of the liquid crystal LC to their top portions is about 0.3 μm or more, and in other words, a difference value d between the top portions of the spacers SP and the surface of the liquid crystal LC from the surface of the substrate SUB2 is about 0.3 μm or more.

If the value of the height H of the column spacers SP is set to be slightly larger than the value of a desired cell gap, e.g., larger by about 0.3 μm, the above-described relationship can be achieved.

FIG. 1B is a diagram showing a case where the substrate SUB1 is pushed to the side of the substrate SUB2 to be changed in shape with respect to the substrate SUB2, and the cell gap can be set to any desired value, e.g., 4 μm.

FIG. 1B shows that the cell gap takes the desired value, e.g., 4 μm, when the height of the spacers SP reaches the value h, e.g., 3.65 μm. In this case, the experiment confirms that the relationship between the initial height H of the column spacers SP and the height h thereof after the cell gap value is derived leads to the following effects by setting the ratio of H/h to be in a range from 108% to 113%.

That is, the repulsion force fof the elastic deformation corresponding to the change of the difference value d is generated, and is balanced with the atmospheric pressure. In this case, the column spacers are deformed first and thus a balance is established with the atmospheric pressure, whereby the liquid crystal can be free from any extra pressure.

Moreover, if the ratio H/h is set to be in a range from 108% to 113%, the elastic. constant will take an appropriate value. Accordingly, even if the spacers SP are to be deformed to a further degree beyond the difference value d, the repulsion force f is responsively increased, and thus the spacers SP are not deformed that much. As a result, the internal pressure corresponding to the additional deformation will be generated in the liquid crystal LC, but this internal pressure is relatively small, thereby being able to solve any possible inconvenience of the liquid crystal LC damaging the sealant SL.

Note here that the above-described deformation of the column spacers SP remains in the range of the elastic deformation of the column spacers SP. As such, when the liquid crystal display device is disassembled, and when the substrate SUB2 is detached from the substrate SUB1, the height h of the column spacers SP can be back to the height H.

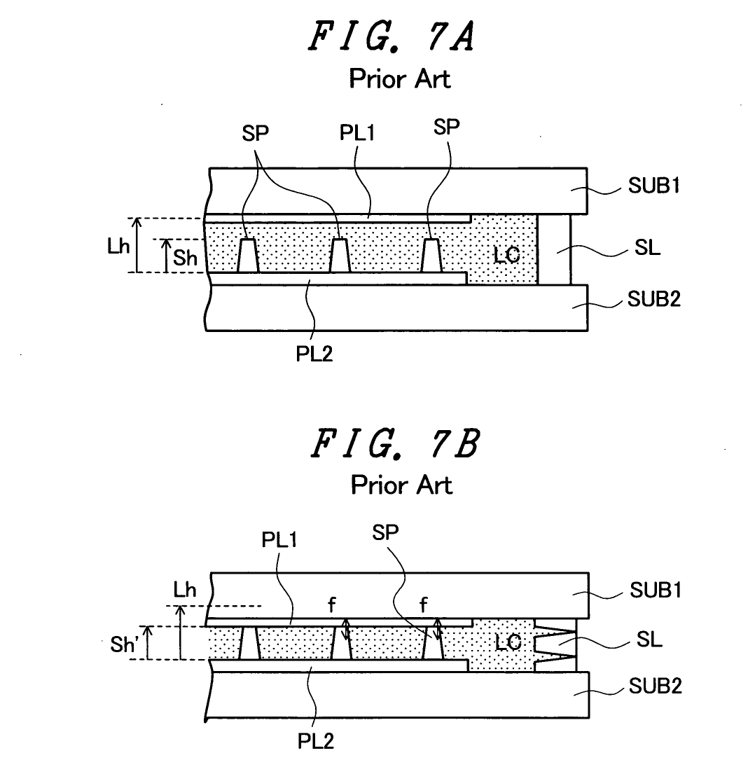

FIGS. 7A and 7B are corresponding to FIGS. 1A and 1B, respectively, and show any inconvenience in a case where the dropping amount of the liquid crystal LC is larger than the appropriate amount in a previous liquid crystal display device.

In FIG. 7A, the height Sh of the column spacers SP is so set as to be lower than the height h thereof in the embodiment of the invention. Therefore, the surface of the liquid crystal LC as a result of excessive dropping resultantly covers the column spacers SP, and the height Lh thereof is higher than the height Sh of the column spacers SP.

As such, when the substrate SUB1 disposed to oppose the substrate SUB2 is pushed to the side of the substrate SUB2, responsively, the liquid crystal LC is considerably increased in internal pressure.

At this time, as shown in FIG. 7B, even if the top portions of the column spacers SP come in contact with the surface of the substrate SUB1 on the liquid crystal side, the substrate SUB1 is prevented from being deformed against the substrate SUB2 due to the internal pressure of the liquid crystal LC. As such, the force f to be generated between the column spacers SP and the substrate SUB1 will be considerably small. This means that the percentage ratio as a result of dividing the initial height of the column spacers SP, i.e., when the spacers SP are not depressed, by the height thereof while the spacers SP are being depressed is considerably close to 100%, i.e., smaller than 108%. That is, the height Sh′ of the column spacers SP shown in FIG. 7B is smaller than the height Sh thereof shown in FIG. 7A, and the difference thereof is considerably small.

In this stage, the liquid crystal LC is penetrated into the sealant SL by its increased internal pressure. This resultantly damages the sealant.

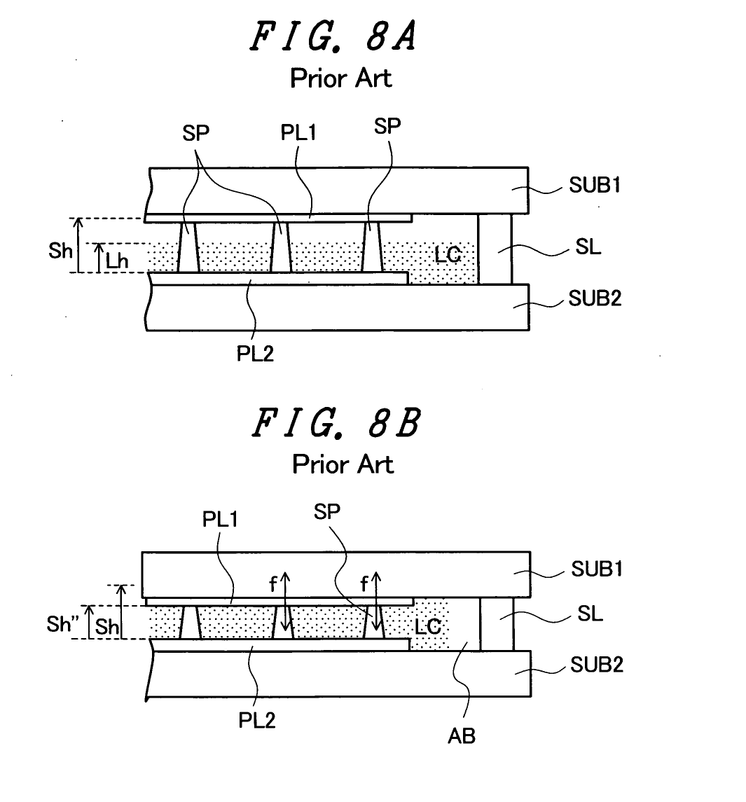

FIGS. 8A and 8B are corresponding to FIGS. 1A and 1B, respectively, and show the inconvenience to be caused when the dropping amount of the liquid crystal LC is smaller than the appropriate amount in the previous liquid crystal display device.

In FIG. 8A, the surface height Lh of the liquid crystal LC when it is not dropped sufficiently in amount is located at a considerably lower position compared with the height Sh of the spacers SP, i.e., configured higher than that in the embodiment of the invention. It means that any excessive amount of air will exist between the substrate SUB1 disposed opposing the substrate SUB2 and the liquid crystal LC.

In this state, when the substrate SUB1 is pushed to the side of the substrate SUB2, the spacers SP are changed in shape until the height Sh is reduced to a value Sh″. However, because it exceeds the level of any appropriate elastic deformation, no further deformation is allowed.

As a result, the excessive amount of air will not be discharged to the outside of the panel but remain in the liquid crystal in the area around the panel as vacuum bubbles AB. In this case, Sh/Sh″ is larger than 113%.

In the embodiment described above, the spacers SP are formed on the side of the substrate SUB2. This is surely not restrictive, and when the spacers SP are formed on the side of the substrate SUB1, the perfectly similar effects can be achieved with the application of the invention, and thus such a configuration will also do.

What is claimed is:

1. A manufacturing method of a liquid crystal display device having a pair of substrates disposed in an opposed manner including a liquid crystal display area with a diagonal length in a range from 1 inch to 5 inches, and a plurality of column spacers is formed in the liquid crystal display area of at least one of the substrates, the method comprising the steps of:
forming a sealant, with a width in a range from 0.4 mm to 1.0 mm, around the liquid crystal display area of the substrate formed with the column spacers;
dropping a liquid crystal into the area enclosed by the sealant on the substrate such that a surface of the liquid crystal has a height lower than a height of the column spacers;
disposing the other substrate to be opposed to the substrate formed with the column spacers, and pushing the resulting pair of substrates in a direction bringing the substrates closer to each other; and
curing the sealant in a state that the column spacers each have the height in a percentage range from 108% to 113% as a result of dividing the height without the pushing by the height with the pushing.

2. The manufacturing method of the liquid crystal display device according to claim 1, wherein
the diagonal length of the liquid crystal display area is set in a range from 1 inch to 4 inches.

3. The manufacturing method of the liquid crystal display device according to claim 1, wherein
the width of the sealant is set in a range from 0.55 mm to 0.85 mm.

4. A liquid crystal display device, comprising:
a pair of substrates disposed in an opposed manner with a liquid crystal sandwiched therebetween;
a sealant being formed around a liquid crystal display area in which the liquid crystal is sealed between the pair of substrates, and having no remaining trace of a liquid crystal sealing port throughout an entire length thereof; and
a plurality of column spacers each fixed inside of the liquid crystal display area of one of the pair of substrates, wherein
a diagonal length of the liquid crystal display area is in a range from 1 inch to 5 inches, and the sealant has a width set in a range from 0.4 mm to 1.0 mm, and
the column spacers each have a height set to have a percentage range from 108% to 113% as a result of dividing a height of the column spacers in a state that only said one of the pair of substrates exists by a height of the column spacers in a state that both of the substrates attached together.

5. The liquid crystal display device according to claim 4, wherein
the diagonal length of the liquid crystal display area is set in a range from 1 inch to 4 inches.

6. The liquid crystal display device according to claim 4, wherein
the width of the sealant is set in a range from 0.55 mm to 0.85 mm.
